(19) United States
(12) Patent Application Publication
(10) Pub. No.: US 2026/0328981 A1
(43) Pub. Date: Oct. 22, 2026

(54) Optical Construction Including At Least Two Films

(71) Applicant: 3M INNOVATIVE PROPERTIES COMPANY, St. Paul, MN (US)

(72) Inventors: Matthew C. Dachel, Baldwin, WI (US); John D. Le, San Jose, CA (US)

(21) Appl. No.: 19/122,985

(22) PCT Filed: Oct. 24, 2023
(86) PCT No.: PCT/IB2023/060730

§ 371 Date: Apr. 21, 2025

Related U.S. Application Data
(60) Provisional application No. 63/382,312, filed on Nov. 4, 2022.

(51) Int. Cl. G02B 5/30; B29D 11/00; G02B 3/02

(52) U.S. Cl. CPC G02B 5/305; B29D 11/0049; B29D 11/0073; G02B 3/02

(57) ABSTRACT

An optical construction includes a substrate and an optical stack disposed on, and substantially conforming to, a first major surface of the substrate. The optical stack includes at least an integrally formed multilayer optical first film facing the substrate and a room-temperature-non-adhesive second film facing away from the substrate. The second film extends beyond a periphery of the first film to bond directly to the substrate such that the second film has a peel strength with the substrate that can be greater than about 100 g/inch. The first film has a peel strength of less than about 50 g/inch with at least one of the second film or the substrate. The optical construction can be an optical lens and the substrate can be a lens substrate.

### TECHNICAL FIELD

The present description relates generally to optical constructions such as optical lenses.

### BACKGROUND

An optical lens can include an optical film disposed on a major surface thereof.

### SUMMARY

In some aspects, the present description provides an optical lens including a lens substrate and an optical stack disposed on, and substantially conforming to, a first major surface of the lens substrate. The optical stack includes at least an integrally formed multilayer optical first film facing the lens substrate and a room-temperature-non-adhesive second film facing away from the lens substrate. The second film extends beyond a periphery of the first film to bond directly to the lens substrate such that the second film has a peel strength with the lens substrate that can be greater than about 100 g/inch. The first film can have a peel strength of less than about 50 g/inch with at least one of the second film or the lens substrate.

In some aspects, the present description provides an optical lens including a lens substrate and an optical stack disposed on, and substantially conforming to, a first major surface of the lens substrate. The optical stack includes at least an integrally formed multilayer optical first film facing the lens substrate and a room-temperature-non-adhesive second film facing away from the lens substrate. The second film extends beyond a periphery of the first film to bond directly to the lens substrate such that the second film has a first peel strength with the lens substrate. The first film has a second peel strength with at least one of the second film or the lens substrate, where the first peel strength can be greater than the second peel strength by at least a factor of about 1.5.

In some aspects, the present description provides an optical lens including a lens substrate and an optical stack disposed on, and substantially conforming to, a first major surface of the lens substrate. The optical stack includes at least an integrally formed multilayer optical first film facing the lens substrate and a room-temperature-non-adhesive second film facing away from the lens substrate. The second film can extend beyond a periphery of the first film to bond directly to the lens substrate such that the second film cannot be separated from the lens substrate without substantial damage to at least one of the second film or the lens substrate. The first film may be separated from at least one of the second film or the lens substrate with little or no damage to each of the first film and the at least one of the second film or the lens substrate.

In some aspects, the present description provides an optical construction including an optical stack and a substrate molded onto the optical stack such that the optical stack substantially conforms to a curved major surface of the substrate. The optical stack includes at least a first film facing the substrate and a room-temperature-non-adhesive second film facing away from the substrate. The second film extends beyond a periphery of the first film to directly bond to the substrate such that the second film can have a peel strength with the substrate of greater than about 100 g/inch. The first film can have a peel strength of less than about 50 g/inch with at least one of the second film or the substrate.

In some aspects, the present description provides an optical construction including an optical stack and a substrate molded onto the optical stack such that the optical stack substantially conforms to a curved major surface of the substrate. The optical stack includes at least a first film facing the substrate and a room-temperature-non-adhesive second film facing away from the substrate. The second film extends beyond a periphery of the first film to directly bond to the substrate such that the second film has a first peel strength with the substrate. The first film has a second peel strength with at least one of the second film or the substrate, where the first peel strength can be greater than the second peel strength by at least a factor of about 1.5.

In some aspects, the present description provides an optical construction including an optical stack and a substrate molded onto the optical stack such that the optical stack substantially conforms to a curved major surface of the substrate. The optical stack includes at least a first film facing the substrate and a room-temperature-non-adhesive second film facing away from the substrate. The second film can extend beyond a periphery of the first film to directly bond to the substrate such that the second film cannot be separated from the lens substrate without substantial damage to at least one of the second film or the lens substrate. The first film may be separated from at least one of the second film or the substrate with little or no damage to each of the first film and the at least one of the second film or the substrate.

In some aspects, the present description provides a method of making an optical construction. The method includes, in sequence: placing first and second films into a mold; substantially filling a cavity of the mold with a molten polymer; and cooling the molten polymer to form a substrate. The first and second films can be placed in the mold with the first film facing the cavity of the mold and being coextensive with an interior portion of the second film where the second film extends beyond a periphery of the first film so that at least one peripheral portion of the second film is exposed to the cavity and where any bonding between the first and second films can be such that the first film may be removed from the second film with little or no damage to either the first or second film. The second film can be a room-temperature non-adhesive film. In some embodiments, after the molten polymer is cooled to form the substrate: the second film has a peel strength with the substrate of greater than about 100 g/inch; and the first film has a peel strength of less than about 50 gram/inch with at least one of the second film or the substrate. In some such embodiments, or in other embodiments, after the molten polymer is cooled to form the substrate: the second film has a first peel strength with the substrate; and the first film has a second peel strength with at least one of the second film or the substrate, where the first peel strength is greater than the second peel strength by at least a factor of about 1.5. In some such embodiments, or in other embodiments, after the molten polymer is cooled to form the substrate: the second film cannot be separated from the substrate without substantial damage to at least one of the second film or the substrate; and the first film may be separated from at least one of the second film or the substrate with little or no damage to each of the first film and the at least one of the second film or the substrate.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-sectional view of an optical construction, according to some embodiments.

FIGS. 2-3 are schematic cross-sectional views of optical stacks, according to some embodiments.

FIG. 4 is a schematic cross-section view of a film, according to some embodiments.

FIG. 5 is a schematic cross-section view of a multilayer optical film, according to some embodiments.

FIG. 6 is a schematic illustration of an optical stack disposed in a mold, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

It may be desired that an optical construction, such as an optical lens, include one or more films disposed on a major surface of a substrate, such as a lens substrate. For example, an optical lens used in optical systems of head-mounted displays can include a reflective polarizer film disposed on a major surface of the lens as described in U.S. Pat. No. 10,678,052 (Ouderkirk et al.), for example. In some cases, an absorbing polarizer film and/or a retarder film, for example, may be included along with the reflective polarizer. In some cases, the materials of a reflective polarizer, or other optical film, does not bond well to the material of a lens substrate. For example, it may be desired for a lens substrate to be formed from cyclic olefin polymer (COP), cyclic olefin copolymer (COC), or polymethylmethacrylate (PMMA) due to desired optical properties (e.g., low birefringence) of such materials, for example, and it may be desired for the reflective polarizer film, or other film, to have outer layers formed from polyesters or polycarbonates which do not bond strongly to the lens substrate material when the lens substrate is formed (e.g., via insert injection molding) on the film.

According to some embodiments of the present description, it has been found that a first film can be disposed on a major surface of a substrate where the first film is substantially unbonded or only weakly bonded to the substrate where a second film covers the first film and extends beyond a periphery of the first film to bond directly to the substrate. The first and second films may be substantially unbonded or only weakly bonded to one another. The first film can be a multilayer optical film such as a reflective polarizer film, for example. Such films may be characterized by an interlayer bonding strength. In some embodiments, the second film is bonded to the substrate with a bonding strength that is no less than the interlayer bonding strength. In some such embodiments, the bonding strength of the optical stack that includes the first and second films to the substrate is at least as great as the interlayer bonding strength due to the bonding strength of the second film to the substrate even when the first film is substantially unbonded or only weakly bonded to the substrate and to the second film.

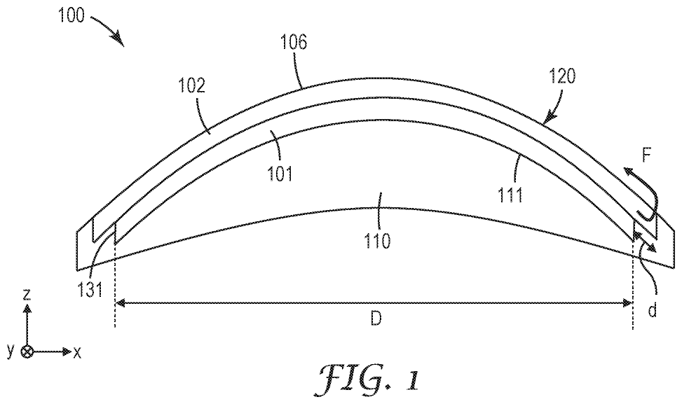

FIG. 1 is a schematic cross-sectional view of an optical construction 100 including an optical stack 120 disposed on a first major surface 111 of a substrate 110, according to some embodiments. The optical stack 120 can substantially conform (e.g., nominally conform or conform up to variations small—e.g., less than about 20, 10, or 5 percent-compared to the thickness of the optical stack) to the first major surface 111. The optical stack 120 can be coextensive with at least a majority (greater than 50% by area) of the first major surface 111 and can conform to the at least the majority of the first major surface 111. The majority of the first major surface 111 can include all of the major surface except end portions, for example. In some embodiments, the first major surface 111 is curved. The substrate 110 can be molded onto the optical stack 120. The substrate may be a lens substrate, a prism (e.g., having a curved surface), or another optical element. The optical construction 100 can be an optical lens and the substrate 110 can be a lens substrate. The lens substrate can be biconvex, plano-convex, positive meniscus, negative meniscus, plano-concave, or biconcave, for example. The lens substrate can be a simple or monolithic lens substrate (e.g., molded onto the optical stack 120) or can be a compound lens substrate (e.g., a first lens substrate molded onto the optical stack 120 and second lens substrate bonded to the first lens substrate).

In some embodiments, the first film 101 is a multilayer optical film as described further elsewhere herein. In some embodiments, the second film 102 is not an adhesive at room temperature (23 degrees Celsius, unless indicated differently). Such films may be referred to as room-temperature-non-adhesive films. In some embodiments, the first film 101 is an integrally formed multilayer optical film. In some embodiments, the integrally formed multilayer optical first film is a reflective polarizer and the second film is at least one of an absorbing polarizer, a retarder, or an optically clear film. In some embodiments, the second film 102 is an integrally formed multilayer optical film that may be a reflective polarizer. Useful reflective polarizers, absorbing polarizers, retarders, and optically clear films include those commercially available from 3M Company, (St. Paul, MN), Teijin Limited (Tokyo, Japan), Dupont Teijin Films (Chester, VA), and Zeon Corporation (Tokyo, Japan), for example. A reflective (resp., absorbing) polarizer can, for a predetermined wavelength range (e.g., 420 nm to 680 nm), substantially reflect (resp., absorb) a first polarization state and substantially transmit an orthogonal second polarization state. A retarder can be a quarter wave retarder for at least one wavelength in a wavelength range of about 400 nm to about 700 nm. An optically clear film can have a luminous transmittance of greater than 80% and an optical haze of less than 10%. In some embodiments, one of the first and second films is a reflective polarizer and the other of the first and second films is at least one of an absorbing polarizer, a retarder, or an optically clear film.

In some embodiments, each of the first and second films 101 and 102 is self-supporting. A self-supporting film is generally thick enough to support itself without requiring an additional substrate for support. For example, a polymer film that is at least about 10 microns can be self-supporting while a coating with a thickness of less than 1 micron may not be self-supporting. In some embodiments, each of the first and second films has an average total thickness of at least about 1, 2, 5, 10, 20, 30, 40, or 50 microns. The average total thicknesses can be up to about 5, 3, 1, or 0.5 mm, for example.

In some embodiments, as schematically illustrated in FIG. 1, for example, a portion of the (e.g., lens) substrate wraps around an edge of each of the first and second films to be substantially flush with a major surface 106 of the second film 102 facing away from the first film 101. In some embodiments, the first film 101 is fully embedded between the second film 102 and the (e.g., lens) substrate 110.

In some embodiments, the second film 102 can extend beyond the periphery 131 of the first film 101 such that the periphery 131 of the first film is completely surrounded by the second film (e.g., in a top or bottom plan view). In some embodiments, the second film can extend from a periphery of the first film by a distance d along a direction tangent to the second film adjacent the periphery of the first film for each location along the periphery of the first film. In some embodiments, the distance d is at least about 1, 2, 3, 4, 5, or 6 percent of a largest diameter D (e.g., diameter in the x-y-plane) of the first film. The distance d can be up to about 25, 20, 15, or 10 percent of the largest diameter D of the first film, for example.

A bonding or peel strength F is schematically illustrated in FIG. 1. The bonding or peel strength F can schematically represent a bonding or peel strength between the second film 102 and the substrate 110, between the optical stack 120 (or the first film 101) and the substrate 110, or between the first and second films 101 and 102. Bonding and peel strengths can be understood to be determined at a 180 degree peel angle and at a 12 inch/min peel rate, unless indicated otherwise.

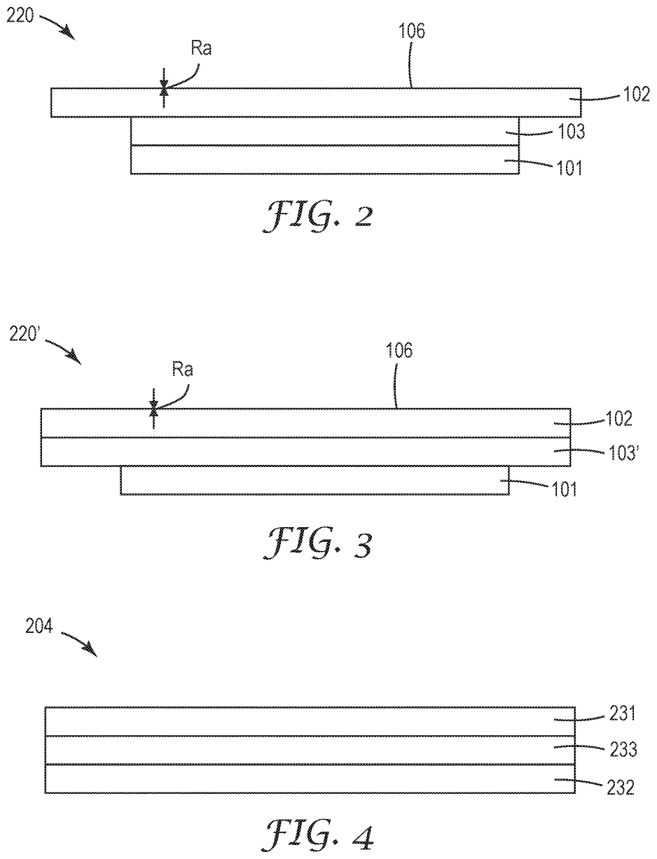

FIGS. 2-3 are schematic cross-sectional views of optical stacks 220, 220′, according to some embodiments. The optical stacks 220, 220′ include the first and second film 101 and 102 and further includes a third film 103, 103′ disposed between the first and second films 101 and 102. The third film 103 can be substantially coextensive with the first film 101, or the third film 103′ can be substantially coextensive with the second film 102, or the third film can be intermediate in extent between the first and second films. In some embodiments, the third film 103 is bonded to, and substantially coextensive with, the first film 101. In some embodiments, the third film 103′ is bonded to, and substantially coextensive with, the second film 102. For example, a bonding layer may be used to bond the third film 103, 103′ to at least one of the first and second films 101, 102, or the third film 103, 103′ may bond to at least one of the first and second films 101, 102 when the substrate is molded onto the optical stack. The third film 103, 103′ can be a room-temperature-non-adhesive film. The third film 103, 103′ may be a self-supporting film and/or may have an average total thickness of at least about 1 micron or in a range described elsewhere herein for the first and/or second films.

Layers or elements can be described as substantially coextensive with each other if at least about 60% by area of each layer or element is coextensive with at least about 60% by area of each other layer or element. Here, area refers to the area of a major surface of the layer or element. In some embodiments, for layers or elements described as substantially coextensive, at least about 70%, or at least about 80%, or at least about 90% by area of each layer or element is coextensive with at least about 70%, or at least about 80%, or at least about 90% by area of each other layer or element.

In some embodiments, the second film 102 has an optically smooth major surface. An optically smooth major surface has a surface roughness substantially less than visible light wavelengths. In some embodiments, the second film 102 has at least one major surface 106 having an arithmetic average surface roughness Ra of less than about 50, 40, 30, 20, or 10 nm. The at least one major surface 106 can be or include the major surface facing away from the first film 101.

FIG. 4 is a schematic cross-section view of a film 204, according to some embodiments. Film 204 may correspond to the first film 101 or the second film 102, for example. Film 204 includes first and second layers 231 and 232 bonded to one another via an adhesive layer 233. The first and second layers 231 and 232 may be third and fourth films. More generally, either or both of the first and second films 101, 102 may be a laminate of two or more layers or films. In some embodiments, each layer of the first film is substantially coextensive with the first film. In some embodiments, each layer of the second film is substantially coextensive with the second film.

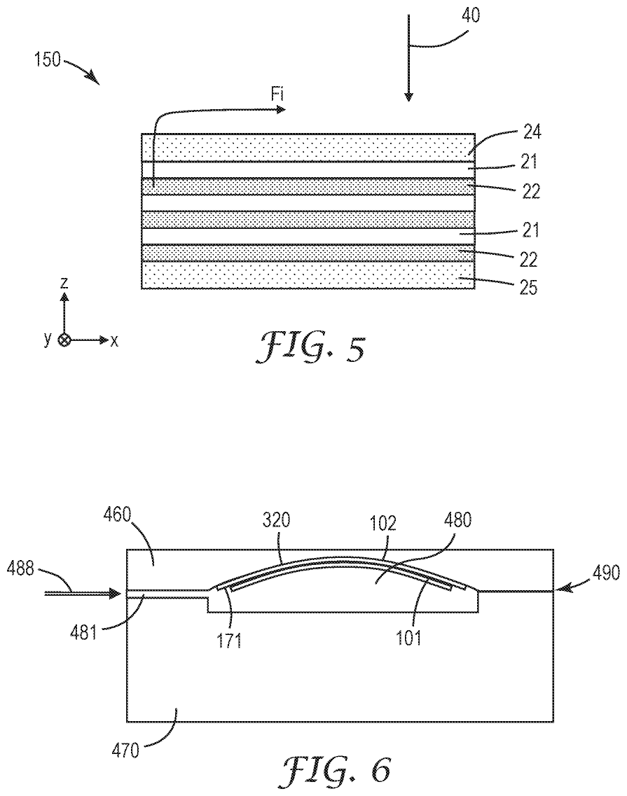

FIG. 5 is a schematic cross-sectional view of a multilayer optical film 150, according to some embodiments. At least one of the first and second films 101 and 102 may be or include a multilayer optical film 150. For example, in some embodiments, the first film 101 is an integrally formed multilayer optical first film corresponding to multilayer optical film 150. As is known in the art, multilayer optical films including alternating polymeric layers can be used to provide desired reflection and transmission in desired wavelength ranges and polarization states by suitable selection of layer thicknesses and refractive index differences. Multilayer optical films and methods of making multilayer optical films are described in U.S. Pat. No. 5,882,774 (Jonza et al.); 6,783,349 (Neavin et al.); 6,949,212 (Merrill et al.); 6,967,778 (Wheatley et al.); and 9,162,406 (Neavin et al.), for example.

In some embodiments, the multilayer optical film 150 includes a plurality of alternating first (21) and second (22) polymeric layers numbering at least 10 in total, where each of the first and second polymeric layers has an average thickness less than about 500 nm. The plurality of first and second polymeric layers 21, 22 may number at least 20, 30, 40, 50, 80, or 100 in total. The total number of layers in the plurality of first and second polymeric layers 21, 22 can be up to 10000, 5000, 2000, 1000, or 800, for example. Each of the first and second polymeric layers 21, 22 can have an average thickness less than about 400, 300, 200, or 150 nm, for example. The average thicknesses can be at least about 20, 30, 40, 50, or 60 nm, for example. In some embodiments, the plurality of alternating first and second layers 21 and 22 are disposed between first and second skin layers 24 and 25. In some embodiments, each of the first and second skin layers 24 and 25 has an average thickness of greater than about 400, 500, 600, 700, 800, 900, 1000, 1250, 1500, 1750, or 2000 nm. The average thickness of each of the skin layers can be up to about 150, 100, 50, 30, 20, or 10 microns, for example.

In some embodiments, the multilayer optical film 150 is a reflective polarizer. In some embodiments, for a substantially normally incident (e.g., within about 30, 20, 10, or 5 degrees of normally incident) light 40 and a visible wavelength range of about 420 nm to about 680 nm, the reflective polarizer has an optical reflectance of greater than about 60, 70, 80, or 90 percent for a first polarization state (e.g., polarized along the x-axis, referring to the illustrated x-y-z coordinate system) and an optical transmittance of greater than about 60, 70, 75, 80, or 85 percent for an orthogonal second polarization state (e.g., polarized along the y-axis).

In some embodiments, the multilayer optical film 150 is integrally formed. As used herein, a first element “integrally formed” with a second element means that the first and second elements are manufactured together rather than manufactured separately and then subsequently joined. Integrally formed includes manufacturing a first element followed by manufacturing the second element on the first element. An optical film including a plurality of layers is integrally formed if the layers are manufactured together (e.g., combined as melt streams and then cast onto a chill roll to form a cast film having each of the layers, and then orienting the cast film) rather than manufactured separately and then subsequently joined.

In some embodiments, an interlayer bonding strength Fi of the integrally formed multilayer optical film is greater than about 50, or 60, or 70, or 80, or 90, or 100, or 200, or 200, or 400, or 500 g/inch. The interlayer bonding strength may be measured using the Delamination Test Method of U.S. Pat. No. 10,288,789 (Johnson et al.), for example, except that a 180 degree peel test with a 12 inch/min peel speed can be used. The interlayer bonding strength can be up to about 5000, 2000, 1000, or 800 g/inch, for example. In some embodiments, the first film 101 is an integrally formed multilayer optical film reflective polarizer. In some embodiments, a bonding strength of the second film 102 to the substrate 110 is no less than an interlayer bonding strength of the integrally formed multilayer optical film reflective polarizer. In some embodiments, a bonding strength of the second film 102 to the substrate 110 is at least about 10, 20, 30, 40, or 50 percent greater than the interlayer bonding strength of the integrally formed multilayer optical film reflective polarizer.

In some embodiments, an optical construction includes an optical stack 120; and a substrate 110 molded onto the optical stack 120 such that the optical stack 120 substantially conforms to a curved major surface 111 of the substrate, where the optical stack 120 includes at least a first film 101 facing the substrate 110 and a room-temperature-non-adhesive second film 102 facing away from the substrate 110. The optical construction 100 can be an optical lens, for example. In some embodiments, an optical lens 100 includes a lens substrate 110; and an optical stack 120 disposed on, and substantially conforming to, a first major surface 111 of the lens substrate 110. In some embodiments, the optical stack 120 includes at least an integrally formed multilayer optical first film 101 facing the lens substrate 110 and a room-temperature-non-adhesive second film 102 facing away from the lens substrate 110.

In some embodiments, the second film 102 extends beyond a periphery 131 of the first film 101 to bond directly to the (e.g., lens) substrate 110 such that the second film 102 has a peel strength F with the (e.g., lens) substrate of greater than about 100, 150, 200, 250, 300, 350, 400, 450, 500, 550, or 600 g/inch, and the first film 102 has a peel strength of less than about 50 g/inch with at least one of the second film 102 or the (e.g., lens) substrate 110. The first film 102 can have a peel strength of less than about 40, 30, 20, 10, 8, or 6 g/inch, for example, with at least one of the second film 102 or the (e.g., lens) substrate 110. In some embodiments, the peel strength of the first film 101 with each of the second film 102 and the (e.g., lens) substrate 110 is less than about 50, 40, 30, 20, 10, 8, or 6 g/inch. The peel strength of the second film 102 from the substrate can be up to about 6000, 4000, 2000, 1000, or 800 g/inch, for example. In some embodiments where the first film 101 is an integrally formed multilayer optical film, the peel strength of the second film 102 with the (e.g., lens) substrate 110 is no less than an interlayer bonding strength of the integrally formed multilayer optical first film.

In some embodiments, the second film 102 extends beyond a periphery 131 of the first film 101 to bond directly to the (e.g., lens) substrate such that the second film 102 has a first peel strength with the (e.g., lens) substrate, and the first film 101 has a second peel strength with at least one of the second film 102 or the (e.g., lens) substrate 110, where the first peel strength is greater than the second peel strength by at least a factor of about 1.5, or 2, 3, 4, 5, 6, 7, 8, 9, 10, 20, 30, 40, 50, 60, 70, 80, 90, or 100. In some such embodiments, or in other embodiments, the first peel strength is greater than about 100 g/inch and the second peel strength is less than about 50 g/inch. The first peel strength can be greater than about 150, 200, 250, 300, 350, 400, 450, 500, 550, or 600 g/inch. The second peel strength can be less than about 40, 30, 20, 10, 8, or 6 g/inch. In some embodiments where the first film 101 is an integrally formed multilayer optical film, the first peel strength is no less than an interlayer bonding strength of the integrally formed multilayer optical film and the second peel strength is less than the interlayer bonding strength.

In some embodiments, the second film 102 is bonded directly to the substrate 110 via diffusion bonding. In some such embodiments, or in other embodiments, the first and second films 101 and 102 are bonded to one another via optical contact bonding. In some such embodiments, or in other embodiments, the second film 102 is bonded to the substrate 110 via optical contact bonding. Diffusion bonding typically results in a substantially stronger bonding than optical contact bonding. In some embodiments, the second film 102 is configured to electrostatically attach to the first film 101 at room temperature. For example, the first and second films can be electrostatically bonded to one another when placed in a mold for injection molding a lens substrate or other substrate onto the optical stack. In some embodiments, a bonding between the second film and the first film and/or between the first film and the substrate may have chemical interactions (e.g., hydrogen bond, silane coupling interaction, surface priming interaction) that result in a weaker bond that a bonding between the second film and the substrate. In some embodiments, this results in the first film being separable from at least one of the second film or the lens substrate with little or no damage to each of the first film and the at least one of the second film or the lens substrate.

In some embodiments, the second film 102 extends beyond a periphery 131 of the first film 101 to bond directly to the (e.g., lens) substrate such that the second film 102 cannot be separated from the (e.g., lens) substrate 110 without substantial damage to at least one of the second film 102 or the (e.g., lens) substrate 110, and the first film 101 may be separated from at least one of the second film 102 or the (e.g., lens) substrate with little or no damage to each of the first film 101 and the at least one of the second film 102 or the (e.g., lens) substrate 110. In some embodiments, the first film may be separated from each of the second film and the lens substrate with little or no damage to each of the first and second films and the (e.g., lens) substrate. Little or no damage to a film or substrate can be understood to mean that there is no damage visible to a person with 20/20 vision when view under Standard Illuminant D65. Little or no damage to a film or substrate can entail little (e.g., less than 5, 4, 3, 2, or 1%) or no change in reflectance for at least visible wavelengths in the case of a reflective film and/or can entail little (e.g., less than 5, 4, 3, 2, or 1%) or no change in haze or light scattering for at least visible wavelengths in an optically clear film or substrate, for example. Substantial damage can be understood to mean that there is damage readily visible to a person with 20/20 vision when viewed under Standard Illuminant D65. Substantial damage can entail substantial reduction (e.g., greater than 5, 10, 15, or 20%) in reflectance for at least one visible wavelength in the case of a reflective film and/or can entail substantial increase in haze (e.g., greater than 5, 10, 15, or 20%) or light scattering for at least one visible wavelength in an optically clear film or substrate, for example. The Standard Illuminant D65 is defined by the International Commission on Illumination (CIE).

The bonding characteristics of the first film to the second film and/or of the second film to the substrate can be tested by cutting a region of the film stack (e.g., with a razor-see, e.g., the Examples) so that the second film can be removed from the first film and/or the first film can be removed from the substrate in the cut region without having to peel the second film directly from the substrate.

In some embodiments where the first film 101 is an integrally formed multilayer optical film, a bonding strength of the second film 102 to the (e.g., lens) substrate 110 is no less than an interlayer bonding strength of the integrally formed multilayer optical film or is at least about 10, 20, 30, 40, or 50 percent greater than the interlayer bonding strength of the integrally formed multilayer optical film. In some such embodiments, or in other embodiments, a bonding strength of the second film 102 to the lens substrate is greater than about 100, 150, 200, 250, 300, 350, 400, 450, 500, 550, or 600 g/inch. In some such embodiments, or in other embodiments, the first film 101 has a bonding strength of less than about 50, 40, 30, 20, 10, 8, or 6 g/inch with at least one of the second film 102 or the substrate 110. The first film 101 can have a bonding strength of less than about 50, 40, 30, 20, 10, 8, or 6 g/inch with each of the second film 102 and the substrate 110.

In some embodiments, an optical lens 100 includes a lens substrate 110; and an optical stack 120 disposed on, and substantially conforming to, a first major surface 106 of the lens substrate. The optical stack includes at least an integrally formed multilayer optical first film 101 facing the lens substrate 110 and a room-temperature non-adhesive second film 102 facing away from the lens substrate 110. The second film 102 extends beyond a periphery of the first film 101 to bond directly to the lens substrate 110. The integrally formed multilayer optical first film 101 can have an interlayer bonding strength greater than 50 g/inch (or in a range described elsewhere herein). In some such embodiments, or in other embodiments, a bonding strength of the second film 102 to the lens substrate 110 is no less than the interlayer bonding strength. In some such embodiments, or in other embodiments, each of a bonding strength of the first film 101 to the lens substrate 110 and a bonding strength of the first film 101 to the second film 102 is substantially less (e.g., by a factor of at least about 2, 3, 4, 5, 6, 7, 8, 9 or 10) than the interlayer bonding strength.

FIG. 6 is a schematic illustration of an optical stack 320 disposed in cavity 480 of a mold 490, according to some embodiments. The cavity 480 is an open cavity that can be substantially filled with molten material to form a lens, for example. Optical stack 320 may correspond to optical stack 120, 220, or 220′, for example. The mold 490 includes first and second portions 460 and 470 defining the cavity 480 therebetween and includes a gate 481 for filling the cavity 480 with a molten polymer 488. Related molds and methods of using the molds for insert molding are described in U.S. Pat. Appl. Pub. No. 2021/0208320 (Ambur et al.). Suitable polymers 488 include COP, COC, and PMMA, for example. Useful polymers can be obtained from Mitsubishi Gas Chemical (Tokyo, Japan) and Zeon Corporation (Tokyo, Japan), for example.

In some embodiments, a method of making an optical construction is provided. The method can include, in sequence: placing first (101) and second (102) films into a mold 490, with the first film 101 facing a cavity 480 of the mold 490 and being coextensive with an interior portion of the second film 102; substantially filling the cavity with a molten polymer 488; and cooling the molten polymer 488 to form a substrate 110. The second film 102 can be a room-temperature non-adhesive film as described elsewhere herein. When placed in the mold, the second film 102 can face, and be in contact with, a curved surface of the first portion 460 of the mold. The first film 101 can be a multilayer reflective polarizer, for example. In some embodiments, when the films are placed in the mold, any bonding between the first and second films is such that the first film 101 may be removed from the second film 102 with little or no damage to either the first or second film. For example, in some embodiments, the first and second films are not attached to one another or are electrostatically attached to one another. In some embodiments, when the films are placed in the mold, the second film 102 extends beyond a periphery of the first film 101 so that at least one peripheral portion 171 of the second film is exposed to the cavity 480. In some embodiments, the second film 102 extends beyond the periphery of the first film 101 such that the periphery of the first film is completely surrounded by the second film 102.

In some embodiments, after the molten polymer is cooled to form the substrate, the at least one peripheral portion of the second film is bonded directly to the substrate via diffusion bonding, for example. In some such embodiments, or in other embodiments, after the molten polymer is cooled to form the substrate, the first and second films are bonded to one another via optical contact bonding, for example. In some such embodiments, or in other embodiments, after the molten polymer is cooled to form the substrate, the first film is bonded to the substrate via optical contact bonding, for example.

In some embodiments, after the molten polymer is cooled to form the substrate, the bonding properties of the films(s) and substrate are as described elsewhere herein. For example, in some embodiments, after the molten polymer is cooled to form the substrate, the second film cannot be separated from the substrate without substantial damage to at least one of the second film or the substrate; and the first film may be separated from at least one of the second film or the substrate with little or no damage to each of the first film and the at least one of the second film or the substrate. As another example, in some embodiments, after the molten polymer is cooled to form the substrate, the second film has a peel strength with the substrate of greater than about 100 g/inch (or in another range described elsewhere herein); and the first film has a peel strength of less than about 50 g/inch (or in another range described elsewhere herein) with at least one of the second film or the substrate. As still another example, in some embodiments, after the molten polymer is cooled to form the substrate, the second film has a first peel strength with the substrate; and the first film has a second peel strength with at least one of the second film or the substrate, where the first peel strength is greater than the second peel strength by at least a factor of about 1.5 (or in another range described elsewhere herein). The peel strengths may simultaneously exhibit any two or more of these properties.

### EXAMPLES

Materials

| Abbreviation | Description | Available from |
|---|---|---|
| RP | 3M IQP E reflective polarizer having | 3M Company, St. Paul, MN |
| | polycarbonate (PC) outer layers | |
| AP | Absorbing polarizer with PC outer layers | 3M Company, St. Paul, MN |
| QW | Teijin FM143 PC-based quarter wave | Teijin Limited, Tokyo, Japan |
| | retarder | |
| COP | ZEONOR RE ZD14-090 cyclic olefin | Zeon Corporation, Tokyo, Japan |
| | polymer | |
| PMMA | OPTIMAS 7500 polymethylmethacrylate | Mitsubishi Gas Chemical, Tokyo, |
| | | Japan |

Sample optical constructions was made as generally described in U.S. Pat. Appl. Pub. No. 2021/0208320 (Ambur et al.) by insert injection molding PMMA onto a film stack indicated in the table below. The optical construction had a circular shape in a top plan view with a diameter of 54 mm. The film stack included a first film facing the substrate formed by the injection molding and an outer second film. Both films were centered on the substrate. In the top plan view, the second film had a diameter of 39 mm and the first film had a diameter of 35 mm. Peel strengths were tested in two ways. In Test 1, a 1 inch wide tape (3M Tape 5413, available from 3M Company, St. Paul, MN) was used to peel the second film from the construction. Results from this test measure the peel strength of the second film to the substrate. In Test 2, a razor was used to cut a region near the center of the film stack from the remainder of the film stack and a sample of the 1 inch wide tape was used to test the peel strength of the cut region. Results from this test measure the lesser of the peel strength of the second film to the first film and the peel strength of the first film to the substrate. The peel tests were 180 degree tests with a peel speed of 12 inch/min. Peel strength was averaged over 2 seconds for each test run. Average over three test runs are reported for each of the tests in the following table.

| | | | Peel | Peel |
|---|---|---|---|---|
| Second | First | | Strength | Strength |
| (Outer) | (Inner) | Substrate | Test 1 | Test 2 |
| Film | Film | Polymer | (g/inch) | (g/inch) |
| RP | COP | PMMA | 606 | 4.6 |
| RP | AP | PMMA | 606 | 0.67 |
| QW | RP | PMMA | 591 | 4.6 |

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. An optical lens comprising:
a lens substrate; and
an optical stack disposed on, and substantially conforming to, a first major surface of the lens substrate, the optical stack comprising at least an integrally formed multilayer optical first film facing the lens substrate and a room-temperature-non-adhesive second film facing away from the lens substrate, the second film extending beyond a periphery of the first film to bond directly to the lens substrate such that the second film has a peel strength with the lens substrate of greater than about 100 g/inch,
wherein the first film has a peel strength of less than about 50 g/inch with at least one of the second film or the lens substrate.

17. The optical lens of claim 16, wherein the peel strength of the second film with the lens substrate is no less than an interlayer bonding strength of the integrally formed multilayer optical first film.

18. The optical lens of claim 16, wherein the peel strength of the first film with each of the second film and the lens substrate is less than about 50 g/inch.

19. The optical lens of claim 16, wherein the second film cannot be separated from the lens substrate without substantial damage to at least one of the second film or the lens substrate, and wherein the first film may be separated from at least one of the second film or the lens substrate with little or no damage to each of the first film and the at least one of the second film or the lens substrate.

20. The optical lens of claim 16, wherein the integrally formed multilayer optical first film is a reflective polarizer and the second film is at least one of an absorbing polarizer, a retarder, or an optically clear film.

21. The optical lens of claim 16, wherein each of the first and second films is self-supporting.

22. The optical lens of claim 16, wherein the second film is bonded directly to the lens substrate via diffusion bonding.

23. An optical lens comprising:
a lens substrate; and
an optical stack disposed on, and substantially conforming to, a first major surface of the lens substrate, the optical stack comprising at least an integrally formed multilayer optical first film facing the lens substrate and a room-temperature-non-adhesive second film facing away from the lens substrate, the second film extending beyond a periphery of the first film to bond directly to the lens substrate such that the second film has a first peel strength with the lens substrate,
wherein the first film has a second peel strength with at least one of the second film or the lens substrate, the first peel strength being greater than the second peel strength by at least a factor of about 1.5.

24. The optical lens of claim 23, wherein the first film may be separated from at least one of the second film or the lens substrate with little or no damage to each of the first film and the at least one of the second film or the lens substrate.

25. The optical lens of claim 23, wherein the second film is configured to electrostatically attach to the first film at room temperature.

26. The optical lens of claim 23, wherein the second film is bonded directly to the lens substrate via diffusion bonding.

27. The optical lens of claim 23, wherein the first and second films are bonded to one another via optical contact bonding.

28. A method of making an optical construction, the method comprising, in sequence:
placing first and second films into a mold, the first film facing a cavity of the mold and being coextensive with an interior portion of the second film, the second film being a room-temperature non-adhesive film, any bonding between the first and second films being such that the first film may be removed from the second film with little or no damage to either the first or second film, the second film extending beyond a periphery of the first film so that at least one peripheral portion of the second film is exposed to the cavity;
substantially filling the cavity with a molten polymer; and
cooling the molten polymer to form a substrate,
wherein after the molten polymer is cooled to form the substrate:
the at least one peripheral portion of the second film is bonded directly to the substrate via diffusion bonding such that the second film cannot be separated from the substrate without substantial damage to at least one of the second film or the substrate; and
the first film may be separated from at least one of the second film or the substrate with little or no damage to each of the first film and the at least one of the second film or the substrate.

29. The method of claim 28, wherein after the molten polymer is cooled to form the substrate, the first and second films are bonded to one another via optical contact bonding.

30. The method of claim 28, wherein the second film extends beyond the periphery of the first film such that the periphery of the first film is completely surrounded by the second film.
